(19) United States
(12) Patent Application Publication
(10) Pub. No.: US 2021/0388903 A1
(43) Pub. Date: Dec. 16, 2021

(54) CLEAN IN PLACE ROTARY SHAFT SEAL

(71) Applicant: Loos Machine & Automation, Colby, WI (US)

(72) Inventor: Brian Kaldunski, Marathon, WI (US)

(21) Appl. No.: 16/898,967

(22) Filed: Jun. 11, 2020

(51) Int. Cl. F16J 15/34

(52) U.S. Cl. CPC F16J 15/34

(57) ABSTRACT

A rotary shaft seal includes a shaft rotatable about an axis, the shaft penetrating a containment wall defining interior and exterior shaft portions. A first face seal surface is provided along an exterior of the containment wall. A rotating seal body is fixed with the shaft and has an inner portion sealed against the shaft. A face seal surface of the rotating seal body faces the first face seal surface. The rotating seal body is slidable between at least two positions along the shaft, including a sealing position in which the first and second face seal surfaces are axially pressed together, and a cleaning position in which the first and second face seal surfaces are separated. The cleaning position provides the rotary shaft seal with a configuration that allows complete penetration of the first and second face seal surfaces by a cleaning solution, without disassembly of the rotary shaft seal.

### BACKGROUND

This disclosure relates to rotary shaft seals, which are known in the art as devices that establish a seal along a rotating shaft so that a first section of the shaft can be in communication with a medium, liquid or otherwise, while a second section of the shaft is sealed from the medium. Numerous designs exist for rotary shaft seals, many of which include cantilevered sealing lips and/or integrated garter springs that apply radially-inward sealing pressure against the shaft surface. While such designs may be more effective than more antiquated simple mechanical packing seals, these designs generally rely on a pressing force against the running surface of the shaft, which can lead to wear of the shaft surface. Such seals may also require disassembly if it is desired to perform a cleaning operation along the shaft.

### SUMMARY

In some aspects, the invention aims to provide a rotary shaft seal that does not create a wear point along the shaft. Further, the rotary shaft seal may be moved, without disassembly, between at least two positions along the shaft, including a sealing position in which two seal-making surfaces are axially pressed together, and a cleaning position in which the two seal-making surfaces are axially separated. In effect, the rotary shaft seal can be simply moved into an unsealed configuration (e.g., by a lever) to allow penetration by a cleaning solution for thorough cleaning. This can be particularly advantageous for uses in food and beverage processing, although the rotary shaft seal may have widespread applicability throughout all types of machinery in various industries.

In one aspect, the invention provides a rotary shaft seal including a shaft rotatable about an axis, the shaft penetrating a containment wall defining interior and exterior portions of the shaft. A first face seal surface is provided along an exterior of the containment wall. A rotating seal body is fixed with the shaft at the exterior portion thereof, the rotating seal body having a radially inner portion sealed against the shaft. The rotating seal body further has a second face seal surface axially facing and registered with the first face seal surface. The rotating seal body is slidable between at least two positions along the exterior portion of the shaft, including a sealing position in which the first and second face seal surfaces are axially pressed together, and a cleaning position in which the first and second face seal surfaces are axially separated. The cleaning position provides the rotary shaft seal with a cleaning configuration that allows complete penetration of the first and second face seal surfaces by a cleaning solution, without disassembly of the rotary shaft seal.

According to another aspect of the invention, a rotary shaft seal is provided for a shaft that penetrates a containment wall. The rotary shaft seal includes a non-rotating face seal surface provided along an exterior of the containment wall, and a rotating seal body fixed with the shaft at a position outside the containment wall such that the rotating seal body is configured to rotate with the shaft about an axis thereof. The rotating seal body has a radially inner portion sealed against the shaft, and a rotating face seal surface axially facing and registered with the non-rotating face seal surface. A linkage is configured to provide relative axial movement between the non-rotating and rotating face seal surfaces. Movement of the linkage provides both a sealing position in which the non-rotating and rotating face seal surfaces are axially pressed together, and a cleaning position in which the non-rotating and rotating face seal surfaces are axially separated. The cleaning position provides the rotary shaft seal with a cleaning configuration that allows complete penetration of the non-rotating and rotating face seal surfaces by a cleaning solution, without disassembly of the rotary shaft seal.

### BRIEF DESCRIPTION OF THE DRAWINGS

FIG. 1 is a perspective via of a rotary shaft seal according to an embodiment of the invention.

FIG. 2 is an end view of the rotary shaft seal of FIG. 1.

FIG. 3 is a top plan view of the rotary shaft seal as shown in FIGS. 1-2. The rotary shaft seal is shown in a first or closed position.

FIG. 4 is a cross-sectional view of the rotary shaft seal taken along line 4-4 of FIG. 3.

FIG. 4A in an enlarged detail view of a portion of the rotary shaft seal as shown in FIG. 4.

FIG. 4B is a rear perspective view of the rotary shaft seal with several elements removed and the shaft made transparent so as to reveal a cross-pin and rotary seal body interface.

FIG. 5 is a top plan view of the rotary shaft seal shown in a second or cleaning position.

FIG. 6 is a cross-sectional view of the wall taken along line 6-6 of FIG. 5.

FIG. 7 is a top plan view of the rotary shaft seal shown in a third or inspection position.

FIG. 8 is a cross-sectional view of the rotary shaft seal taken along line 8-8 of FIG. 7.

### DETAILED DESCRIPTION

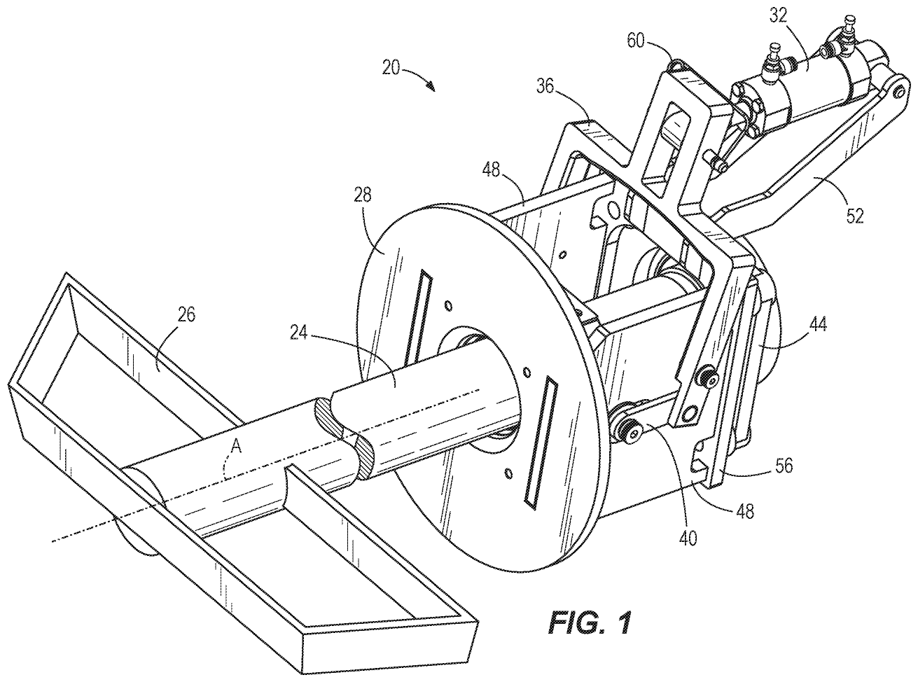

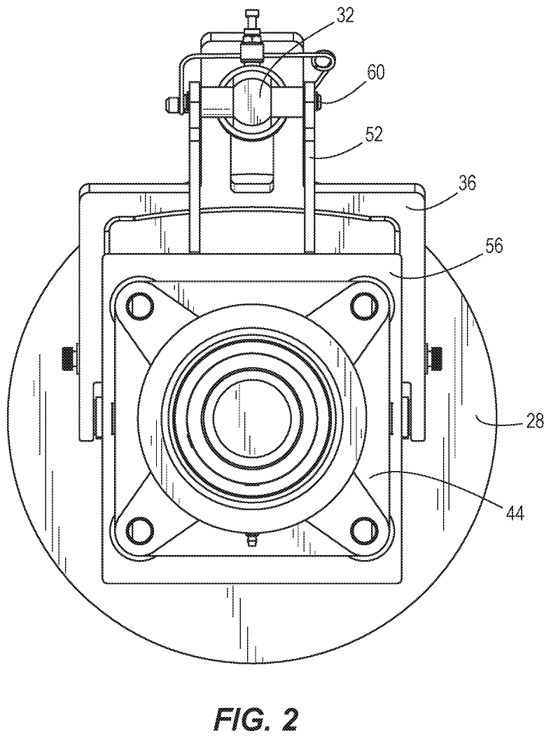

FIGS. 1 and 2 illustrate a rotary shaft seal 20 according to one construction of the present disclosure. A shaft 24 is provided through a containment wall 28 and configured for rotation about an axis A. The shaft 24 penetrates the wall 28 such that a portion of the shaft 24 is on an interior side of the wall 28 (left in FIG. 1) and a portion of the shaft 24 is on an exterior side of the wall 28 (right in FIG. 1). The wall 28, only a portion of which is shown, can form part of a container or vessel for containing a work product. In some examples, the work product can be food product or ingredients thereof. The work product may be a flowable medium—liquid or otherwise. The container or vessel formed at least partially by the wall 28 can be entirely enclosed, open on one side, or a closed container that is selectively opened by a closure member such as a door, cover, lid, etc. Within the container or vessel, the shaft 24 can turn a working implement 26 such as for example, an auger or mixing paddle. As described in further detail below, the rotary shaft seal 20 provides a seal to maintain the interior contents of the vessel inside the wall 28 without leaking out along the shaft 24, despite the shaft 24 being adapted for rotation while penetrating the wall 28. The rotary shaft seal 20 thus has a sealed configuration as shown in FIGS. 1 to 4B. However, the rotary shaft seal 20 also has another position—an open or cleaning position in which the seal is intentionally broken, allowing penetration of seal surfaces by a cleaning solution, without disassembly of the rotary shaft seal 20.

A powered actuator 32 (e.g., pneumatic cylinder) can be provided to move the rotary shaft seal 20 between sealed and open configurations. As shown, the actuator 32 operates through a linkage provided at least in part by a first link or “yoke” 36 and a second or “driving” link 40. The yoke 36 is pivotally coupled to one or more frame elements 48 of the rotary shaft seal 20 such that the yoke 36 provides a lever. The connection between the driving link 40 and the elements forming the openable seal are described in further detail below. The frame elements 48, shown here as two parallel, spaced plates, have first ends fixedly secured to the wall 28. For example, a portion or edge of each frame element 48 may fit into or through the wall 28, and the frame element 48 may be bonded or welded to the wall 28 in some constructions. In other constructions, the frame elements 48 may be fixedly secured to the wall 28, or relative thereto, by other means including non-permanent means including for example threaded or other types of fasteners. At opposite ends of the frame elements 48, the rotary shaft seal 20 can optionally include a shaft bearing 44 providing rotational support to the shaft 24 (e.g., at an end or intermediate portion of the shaft 24). The shaft bearing 44 can be a rolling element bearing, and may include one or more rows of tapered rolling elements. However, any application-appropriate type of bearing may alternately be used to rotationally support the shaft 24. The shaft bearing 44 can be coupled directly to the frame elements 48, or indirectly coupled, for example through an additional rear frame element or plate 56. The rear frame plate 56 is a plate oriented perpendicular to the frame elements 48 and arranged such that a portion of the shaft 24 passes through the rear frame plate 56. As illustrated, an actuator support frame 52 of the rotary shaft seal 20 comprising one or more frame elements can extend from the frame elements 48 and/or rear frame element 56 so support at least a portion of the powered actuator 32 in operative position. In other constructions, the powered actuator 32 can be supported in other ways, for example separately from the rotary shaft seal 20. Of course, in other embodiments there may be no powered actuator whatsoever, and the rotary shaft seal 20 may be operated exclusively by hand of the human operator. In the case of a powered actuator 32, a release pin 60 can be provided for decoupling the output shaft of the powered actuator 32 from the yoke 36 so that the yoke 36 can be operated manually (in the event of power loss to the actuator 32 or another malfunction).

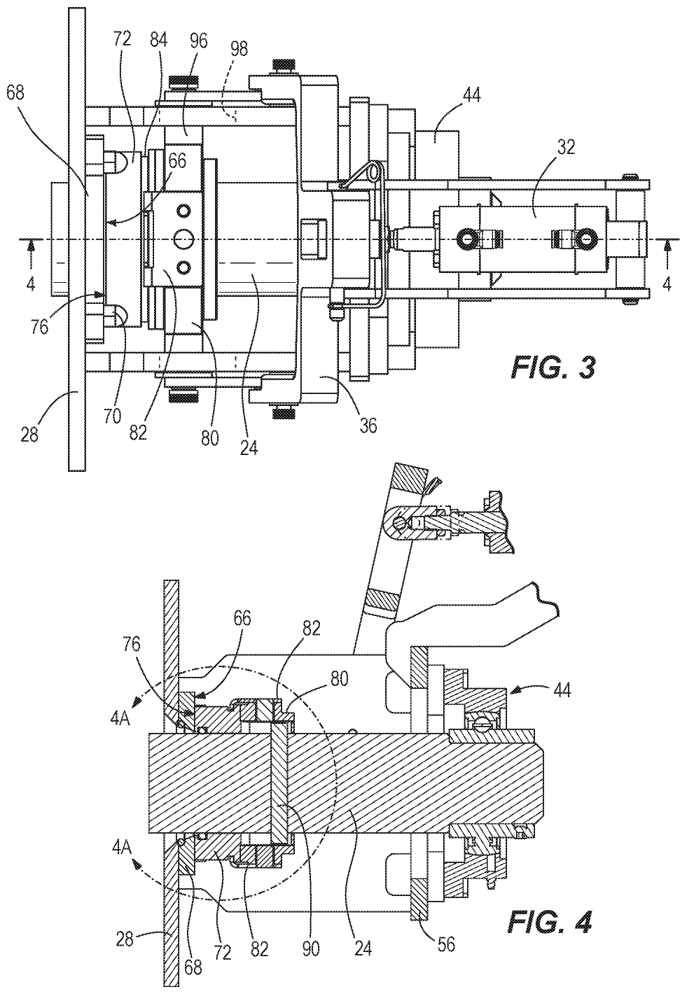

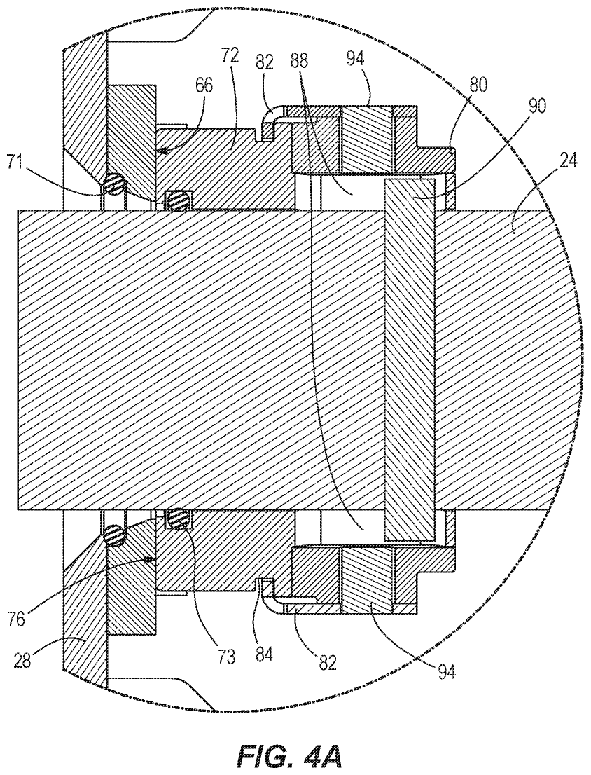

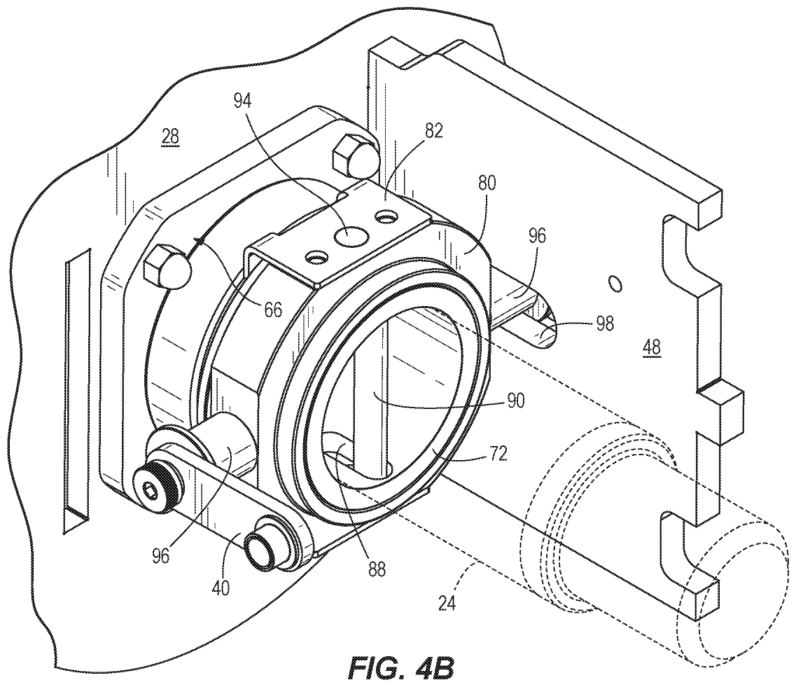

Referring primarily to FIGS. 3 and 4, the functional sealing elements are described in detail. These figures illustrate the sealed or closed position of the rotary shaft seal 20. A first face seal surface 66 is provided along an exterior of the containment wall 28. As illustrated, the first face seal surface 66 is provided by a separate plate or disc 68 secured to the containment wall 28, for example by a plurality of fasteners 70. An O-ring 71 or other seal is provided between the wall 28 and the member 68 providing the first face seal surface 66 such that the fasteners 70 compress the O-ring 71 therebetween (see FIG. 4A). In other constructions, the first face seal surface 66 can be provided as an integral portion of the wall 28. The first face seal surface 66 can be a flat metallic surface (e.g., of 316 stainless steel). The surface 66 has a normal surface vector parallel to the shaft axis A. Next to the first face seal surface 66, a seal body 72 is provided fixed with the shaft 24 at the exterior portion thereof. Thus, the seal body 72 is a rotating seal body. The rotating seal body 72 has a radially inner portion sealed against the shaft 24 (e.g., with an O-ring 73 or other seal, FIG. 4A). The rotating seal body 72 further has a second face seal surface 76 axially facing and registered with the first face seal surface 66. The rotating seal body 72 is slidable between at least two positions along the exterior portion of the shaft 24, including the sealing position shown in FIGS. 3 and 4 in which the first and second face seal surfaces 66, 76 are axially pressed together. As shown by the phantom lines in FIG. 4, the actuator 32 can be positioned such that the sealing position between the surfaces 66, 76 is achieved before reaching maximum stroke (in the retraction direction as shown)—leaving reserve stroke in the actuator 32 to account for wear between the surfaces 66, 76 with use over time. Thus, even as one or both surfaces 66, 76 wear, the actuator 32 is able to achieve a tight pressing force and maintain the surfaces 66, 76 with zero spacing distance. The second face seal surface 76 provided on the rotating seal body 72 can be configured to be the softer, wearable surface of the face seal arrangement. For example, the seal body 72 can be a plastic bushing. The seal body 72 can be constructed of an engineering thermoplastic such as Polyoxymethylene (POM), also known as acetal. In some constructions, the material of the seal body 72 is Celcon® acetal copolymer which is available from Celanese Corp. of Irving, Tex. The rotary shaft seal 20, or at least the sealing portions thereof can be FDA compliant for contact with food product.

The seal body 72 is fixed for rotation with the shaft 24 and movable along the shaft 24 by a seal puller constructed of one or more pieces as best shown in FIGS. 4A and 4B. The seal puller of the illustrated construction includes a seal puller body 80 and pair of diametrically-opposed outer flange plates 82 fixedly secured to the body 80. The flange plates 82 are provided with respective tangs or grippers that engage the rotating seal body 72, for example a recess or groove 84 therein. As shown, the rotating seal body 72 includes a circumferential groove about its radially outer cylindrical surface. Although this has potential to be a dynamic interface during rotation of the shaft 24, clearance may be provided here when the seal puller body 80 bears axially against the rotating seal body 72 to close the face seal surfaces 66, 76 as shown. The flange plates 82 can be provided in an alternate number and/or arrangement. Likewise, the engagement between the seal puller and the seal body 72 may be provided by alternate structures that provide a coupling allowing relative rotation and axial driving of the seal body 72 by the seal puller. The engagement between the flange plates 82 and the groove 84 enables the seal puller to exert an axial force on the rotating seal body 72 for sliding between multiple positions along the shaft 24. With continued reference to FIGS. 4A and 4B, the rotating seal body 72 further includes diametrically-opposed openings 88. Rotation is imparted to the rotating seal body 72 by a pin 90 that passes through a cross-aperture in the shaft 24, the ends of the pin 90 positioned within and engaging the respective openings 88. Each of the openings 88 is axially elongated to form a slot that facilitates axial movement of the rotating seal body 72 along the shaft 24 (since the shaft 24 does not shift axially when switching the rotary shaft seal 20 between positions). Although the pin 90 may be assembled into place by passing through corresponding apertures in the seal puller body 80 and optionally also in the flange plate(s) 82, the pin 90 does not engage with the seal puller once assembled, and the assembly aperture(s) can be closed by one or more plugs 94 that restrain the pin 90 against shifting away from a central position. The seal puller has a sliding interface established with the frame elements 48, including pins or posts 96 that extend from opposite sides of the seal puller body 80 and pass through axially elongated slots 98 (FIGS. 3 and 4B) in each of the frame elements 48. Thus, the seal puller is guided for axial movement by the frame elements 48 of the rotary shaft seal 20.

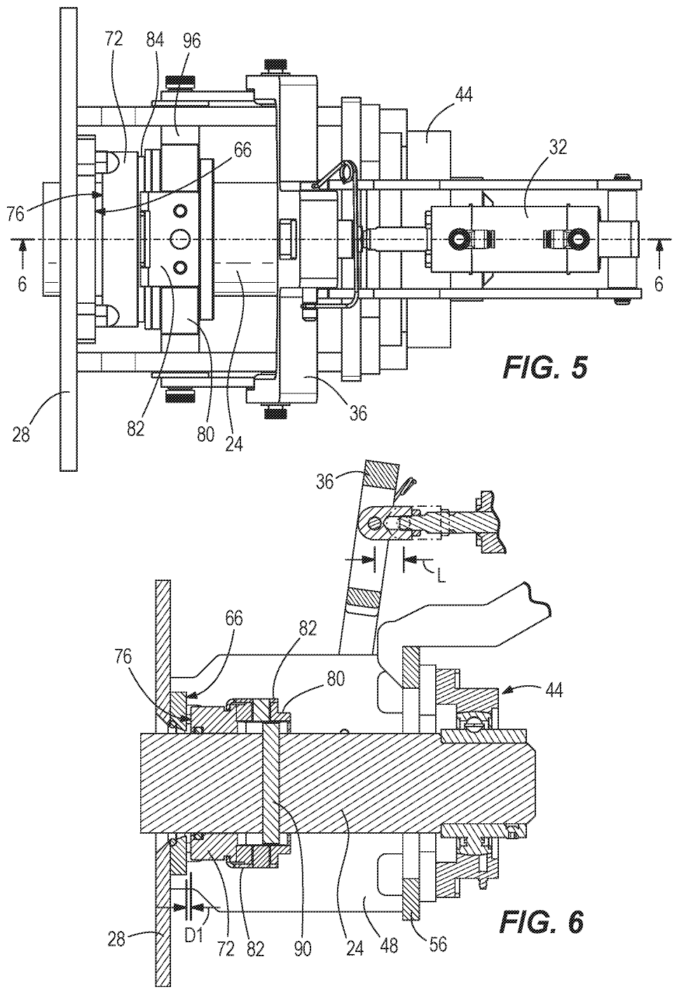

FIGS. 5 and 6 illustrate the rotary shaft seal 20 following movement of the actuator 32 to drive the rotary shaft seal 20, particularly the seal puller body 80, the flange plates 82, and the rotating seal body 72, to the second or cleaning position, for example after extending the actuator 32 by a length L. In the cleaning position of FIGS. 5 and 6, the first and second face seal surfaces 66, 76 are axially separated by a first distance D1 measured axially. In some constructions, the first distance D1 can be 0.050 inch or greater, though generally less than 0.25 inch. In some constructions, the first distance D1 can be from 0.090 inch to 0.100 inch, or about 3/32 inch. The actuator movement length L between the sealing and cleaning positions can be at least 5 times the first spacing distance D1, and in some constructions can be at least 10 times the first spacing distance. The first spacing distance D1 is set so as to achieve full surface penetration or coverage of cleaning solution across both face seal surfaces 66, 76 (360 degrees of the seal surfaces 66, 76 about the axis A). Full coverage for cleaning is preferably achieved without resorting to shaft turning or modulation, although the shaft 24 may rotate or oscillate to some degree during cleaning in some constructions. Thus, it will be appreciated that the first spacing distance D1 cannot be too large, or the cleaning solution will simply run freely out along the bottom side. The second position of the actuator 32 can be adjusted through an interface to a controller (e.g., microprocessor or programmable logic controller), or manually adjusted, to achieve the most desirable spacing distance for cleaning. The cleaning solution may be a liquid (e.g., water-based) introduced to the interior of the vessel and intentionally leaked out through the open rotary shaft seal 20 to clean the same. The cleaning solution within the vessel may be pressurized above ambient to facilitate flow out through the rotary shaft seal 20. Cleaning the rotary shaft seal 20 in this way may enhance the ability of the overall vessel, machine, or facility to be approved during USDA inspection.

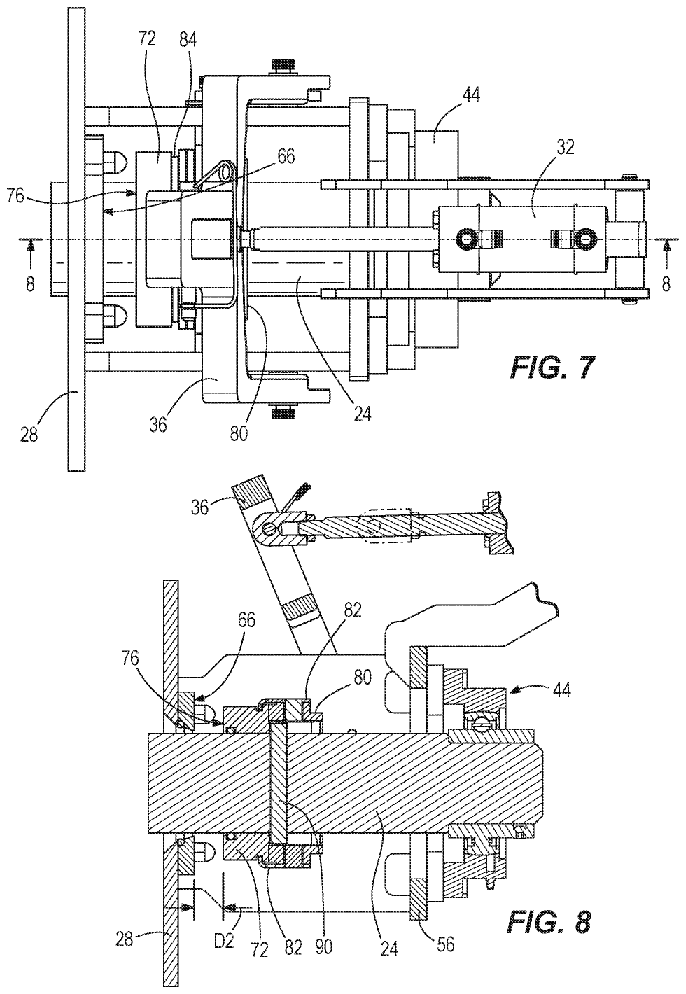

Turning now to FIGS. 7 and 8, an additional configuration of the rotary shaft seal 20 is illustrated. In this configuration, the rotating seal body 72 is in a position of further separation from the first face seal surface 66. This may be achieved by further extension of the actuator 32, beyond the length L of FIG. 6. As shown in FIG. 8, a second spacing distance D2 is presented between the two face seal surfaces 66, 76. The second spacing distance D2 can be greater than 0.500 inch, for example 1.00 inch+/−0.125 inch or 1.00 inch+/−0.25 inch. The purpose for the rotary shaft seal 20 being provided with the second spacing distance D2 is not necessarily for cleaning, but rather visual inspection. As such, the face seal surfaces 66, 76 are spaced sufficiently for direct or indirect visual observation so that cleanliness and/or damage can be detected. Although the rotary shaft seal 20 can be designed to provide movement from the sealing position to both the cleaning and inspection positions by the powered actuator 32 or another suitable actuator, in some constructions disconnection of the actuator 32 from the linkage (e.g., by manual removal of the release pin 60) may be required so that the yoke 36 can be manually operated as a lever, without the actuator 32, to achieve the inspection position. Since the act of inspection already requires human presence and interaction, this manual act is a minimal detriment, and in turn, it can enable the use of a smaller (e.g., shorter stroke) powered actuator 32 than would otherwise be necessary to provide the throw necessary to move the rotating seal body 72 to the second spacing distance D2.

In use, the rotary shaft seal 20 is closed or sealed in the sealing position of FIGS. 1 to 4B. The shaft 24 that penetrates the wall 28 is rotated. If so equipped, the bearing 44 of the rotary shaft seal 20 provides rotational support to the shaft 24. A flowable medium within the vessel is contained so as to not leak to the exterior along the shaft 24. The seal along the shaft 24 is achieved by the combination of the dynamic face seal established between the surfaces 66, 76 in tandem with having the first or non-rotating face seal surface 66 being either integral with the wall 28 or sealed to the wall, while the rotating seal body 72 is sealed to the outside surface of the shaft 24 to rotate therewith. At periodic intervals, or when otherwise deemed necessary, the vessel may need to undergo cleaning, including cleaning of the rotary shaft seal 20. A cleaning solution is introduced into the vessel, and the rotary shaft seal 20 is operated, manually or by the automated actuator 32, to change from the sealing position to the cleaning position, which is an unsealed or leak-inducing position. As such, cleaning solution seeps through between the face seal surfaces 66, 76 (or is actively driven by pressurization or pumping of the cleaning solution) so that the cleaning solution achieves full coverage or penetration across the face seal surfaces 66, 76. Moving from the sealing to cleaning positions is accomplished without needing to release a radially-inward squeezing or clamping force applied onto the outside surface of the shaft 24. Following cleaning, the linkage may be operated in reverse to re-seal the face seal surfaces 66, 76 together for the next cycle of use. Alternately, before returning to the sealed position, the rotary face seal 20 may first be moved into the inspection position in which the face seal surfaces 66, 76 are further separated than in the cleaning position so that an inspection procedure can be completed before returning the apparatus to use.

The embodiments described above and illustrated in the figures are presented by way of example only, and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims. Various features of the invention are set forth in the following claims.

What is claimed is:

1. A rotary shaft seal comprising:
a shaft rotatable about an axis, the shaft penetrating a containment wall defining interior and exterior portions of the shaft;
a first face seal surface provided along an exterior of the containment wall;
a rotating seal body fixed with the shaft at the exterior portion thereof, the rotating seal body having a radially inner portion sealed against the shaft, the rotating seal body further having a second face seal surface axially facing and registered with the first face seal surface;
wherein the rotating seal body is slidable between at least two positions along the exterior portion of the shaft, including a sealing position in which the first and second face seal surfaces are axially pressed together, and a cleaning position in which the first and second face seal surfaces are axially separated, the cleaning position providing the rotary shaft seal with a cleaning configuration that allows complete penetration of the first and second face seal surfaces by a cleaning solution, without disassembly of the rotary shaft seal.

2. The rotary shaft seal of claim 1, further comprising a frame configured to support the rotating seal body for axial movement along the shaft, the frame further supporting a lever coupled to the rotating seal body and configured to drive axial movement thereof in response to pivoting of the level on the frame.

3. The rotary shaft seal of claim 1, wherein the first face seal surface is provided by a separate plate or disc secured and sealed to the containment wall.

4. The rotary shaft seal of claim 1, wherein the first face seal surface is spaced radially from the shaft so as to make no contact therewith.

5. The rotary shaft seal of claim 1, wherein the first and second face seal surfaces are FDA compliant for contact with food product.

6. The rotary shaft seal of claim 1, wherein in the cleaning position, the first and second face seal surfaces are axially separated by a first spacing distance that is at least 0.050 inch and less than 0.25 inch.

7. The rotary shaft seal of claim 1, wherein in the cleaning position, the first and second face seal surfaces are axially separated by a first spacing distance that is at least 0.090 inch and not more than 0.100 inch.

8. The rotary shaft seal of claim 1, further comprising a powered actuator coupled to the rotating seal body such that movement of the powered actuator is configured to drive the movement of the rotating seal body between the sealing and cleaning positions.

9. The rotary shaft seal of claim 8, wherein the powered actuator is coupled to the rotating seal body through a linkage, and wherein disconnection between the powered actuator and the linkage enables additional range of movement of the linkage to move the rotating seal body to an inspection position in which the first and second face seal surfaces are axially separated further than the cleaning position.

10. The rotary shaft seal of claim 9, wherein the first and second face seal surfaces are axially separated by over 0.500 inch in the inspection position.

11. A rotary shaft seal for a shaft that penetrates a containment wall, the rotary shaft seal comprising:
a non-rotating face seal surface provided along an exterior of the containment wall;
a rotating seal body fixed with the shaft at a position outside the containment wall such that the seal body is configured to rotate with the shaft about an axis thereof, the seal body having a radially inner portion sealed against the shaft, the seal body further providing a rotating face seal surface axially facing and registered with the non-rotating face seal surface; and
a linkage configured to provide relative axial movement between the non-rotating and rotating face seal surfaces, movement of the linkage providing both a sealing position in which the non-rotating and rotating face seal surfaces are axially pressed together, and a cleaning position in which the non-rotating and rotating face seal surfaces are axially separated, the cleaning position providing the rotary shaft seal with a cleaning configuration that allows complete penetration of the non-rotating and rotating face seal surfaces by a cleaning solution, without disassembly of the rotary shaft seal.

12. The rotary shaft seal of claim 11, wherein the non-rotating face seal surface is a metallic surface provided by a separate plate or disc secured and sealed to the containment wall.

13. The rotary shaft seal of claim 12, wherein, the rotating seal body including the rotating face seal surface is a plastic body encircling the shaft.

14. The rotary shaft seal of claim 11, wherein the rotating seal body is coupled for rotation with the shaft by a pin through the shaft, the pin being housed in at least one axially elongated opening in the rotating seal body along.

15. The rotary shaft seal of claim 15, wherein the linkage is coupled to axially move the rotating seal body along the shaft.

16. The rotary shaft seal of claim 11, further comprising a powered actuator coupled to drive the linkage.

17. The rotary shaft seal of claim 16, wherein disconnection between the powered actuator and the linkage enables additional range of movement of the linkage to provide an inspection position in which the non-rotating and rotating face seal surfaces are axially separated further than the cleaning position.

18. The rotary shaft seal of claim 17, wherein the non-rotating and rotating face seal surfaces are axially separated by over 0.500 inch in the inspection position.

19. The rotary shaft seal of claim 11, wherein the non-rotating and rotating face seal surfaces are FDA compliant for contact with food product.

20. The rotary shaft seal of claim 11, wherein in the cleaning position, the non-rotating and rotating face seal surfaces are axially separated by a first spacing distance that is at least 0.050 inch and less than 0.25 inch.
